(19) United States
(12) Patent Application Publication
(10) Pub. No.: US 2025/0155087 A1
(43) Pub. Date: May 15, 2025

(54) System and Method for Transferring Temperature Sensitive Fluids

(71) Applicant: NEXANS, Courbevoie (FR)

(72) Inventors: Gerald GÜNZEL, VECHELDE (DE); Ralf EGERER, HANNOVER (DE); Anthony COMBESSIS, AMIENS (FR)

(21) Appl. No.: 18/912,476

(22) Filed: Oct. 10, 2024

(30) Foreign Application Priority Data
Oct. 12, 2023 (EP) 23306780.0

(51) Int. Cl. F17C 7/02

(52) U.S. Cl. CPC F17C 7/02; F17C 2205/0355; F17C 2205/0367; F17C 2205/037; F17C 2223/0161

(57) ABSTRACT

A transfer system is provided for transferring temperature sensitive fluids from a supply tank to a receiver tank. The supply and the receiver tank (101,102) are fluidly connected by a piping arrangement comprising at least two thermally insulated transfer lines (103a, 103b) and first and second piping assemblies (104a-d) associated with the receiver and the supply tank, respectively. One end of each transfer line is connected with one of the supply and receiver tank and the other end of each transfer line is provided with a coupling for coupling the other end with the other one of the supply and receiver tank. The transfer system (100) is selectively operable in a transfer mode and an idle mode by appropriately coupling and decoupling the first and second transfer lines. In either mode the piping arrangement remains at or close to an operating temperature of the transfer system in the transfer mode.

### RELATED APPLICATION

This application claims the benefit of priority from European Patent Application No. 23 306780.0, filed on Oct. 12, 2023, the entirety of which is incorporated by reference.

### FIELD

The present disclosure relates to a transfer system for transferring temperature sensitive fluids from a supply tank to a receiver tank.

### BACKGROUND

Loading systems in many scales for a nearly uncountable number of fluids are essential parts of the global supply chain infrastructure. They are used to transfer various liquid or gaseous substances between a mostly static storage tank and a mostly mobile receiving tank. Typical applications include but are not limited to tanker loading, fuel bunkering for cargo ships as well as loading/unloading of rail tanks and tank cars. Some of these fluids are temperature sensitive, i.e. must be kept at low or high temperatures to keep them in a liquid phase. For instance, cryogenic gases such as liquefied hydrogen must be kept cold at 20 K to stay in the liquid phase

In contrast to that, e.g. sulfur has to be kept at 135° C.-140° C. for transportation and to prevent it from solidifying and blocking a transfer line.

Cold and cryogenic liquefied gases such as liquefied natural gas (LNG), liquefied hydrogen (LH2) and ammonia (NH3) are becoming increasingly important as energy carriers of climate-neutral energy sources.

However, many substances that are charged are highly flammable, toxic, and/or otherwise hazardous and, therefore, must not be released into the environment and/or they have to be kept at a specific temperature to preserve their characteristics, e.g. to keep them in liquid state. The processes of coupling and uncoupling loading systems from a receiver tank are particularly critical. The preparation of the loading systems to be ready to transfer the fluid as well as to be ready to decouple the loading system from the receiver tank is very laborious.

Currently existing solutions for cryogenic fluids like LH2 and LNG have lines with a shut-off valve and an open coupling at one end. The section between the shut-off valve and the coupling is in contact with the ambient air in the idle state. The other end of these lines is connected to a supply tank. For the transfer operation, the coupling is connected to a mating coupling of the receiver tank. Subsequently, the air-wetted sections have to be purged and the complete transfer system has to be cooled down to operation temperature. After the transfer this section has to be drained, purged and warmed up before decoupling (WO2017010095A1).

Another loading system is described in U.S. Pat. No. 6,244,053B1. In this solution the fluid circulates through the transfer lines to keep them cold. But similar to the solution in WO2017010095A1 the section between the shut-off valve and the coupling is in contact with the ambient air in the idle state and not cooled by the circulating fluid. This section has to be purged and cooled down to operating temperature to be ready for transfer.

Other solutions in the market consist of lines needed to be connected to both the supply tank and the receiver tank before each transfer. Thus, the whole line is in contact with the ambient air in the idle state and has to be prepared for transfer and decoupling as described above.

Such configurations require to apply long multi-step purging procedures before the lines are ready to transfer and to decouple after transfer, respectively. In the case of transferring cryogenic fluids/hot fluids the coupling sections and transfer lines have to be cooled down/heated up to specific temperatures.

The current solutions for cryogenic fluids like e.g. liquefied gases LH2 and LNG, for safe handling, after coupling the transfer system to the receiver tank, the line must first be purged carefully with dry inert gas and then with gaseous fluid. This prevents ambient air and inert fluid from the open section from entering the line system. Otherwise this would result in contamination of the cryogenic fluid and formation of ice from water and frozen gas inside the line.

The current solutions for cryogenic fluids e.g. like LH2 and LNG, for safe handling, before disconnecting the transfer system from the receiver tank, the line must be warmed up to ambient temperature first with warm gaseous fluid (e.g. gaseous hydrogen (H2), compressed natural gas (CNG)) to prevent ice forming inside the line. In the second step the line has to be purged with inert gas to prevent the gaseous fluid entering the environment after disconnection.

In current transfer systems for transferring cryogenic fluid, the lines are at ambient temperature when idle. Therefore, they must be cooled to a temperature corresponding to the temperature of the liquified fluid after coupling. Disadvantageously, cooling procedures are time consuming, costly and generate boil-off gases.

Existing transfer systems for hot fluids must first be purged after coupling the transfer system to the receiver tank with dry inert gas and fluid for safe handling. This prevents ambient air from the open section of the transfer line from entering the transfer system. This is important because air in the transfer system would result in contamination of the fluid and/or hazardous chemical reactions with e.g. oxygen. Additionally, the transfer system has to be warmed up to operating temperature to avoid e.g. clogging the transfer system by solidification of the transferred fluid when it gets into contact with a cold transfer system. After the transfer of the fluid is completed, the transfer system has to be disconnected from the receiver tank. However, safe handling requires that before disconnecting the transfer system from the receiver tank, the line must be purged with inert fluid to prevent the hazardous fluid that remains in the line after the transfer from entering the environment after disconnection.

Purging and flushing the transfer system before and after the actual fluid transfer and cooling down or warming up the transfer system requires considerable material and energy input on the one hand, and on the other hand this results in long set-up times for each transfer operation.

In view of the limitations of existing transfer systems, there remains a desire for a transfer system to overcome or at least improve one or more of the problems mentioned at the outset.

### SUMMARY

According to a first aspect the present disclosure suggests a transfer system for transferring temperature sensitive fluids from a supply tank to a receiver tank. The supply and the receiver tank are fluidly connected by a piping arrangement comprising at least two thermally insulated transfer lines and first and second piping assemblies associated with the receiver and the supply tank, respectively. One end of each transfer line is connected with one of the supply and receiver tank and the other end of each transfer line is provided with a coupling for coupling the other end with the other one of the supply and receiver tank. The transfer system is selectively operable in a transfer mode and an idle mode by appropriately coupling and decoupling the first and second transfer lines.

In the transfer mode of the transfer system the first and the second transfer lines fluidly connect the supply tank with the receiver tank, such that fluid flows through the first and second transfer lines and the first and second pipe assemblies.

In the idle mode of the transfer system the first and second transfer lines form a closed loop enabling a continuous flow of fluid through the first and second transfer lines, and the first and the second pipe assemblies are part of the closed loop enabling a continuous flow of fluid through the first and the second pipe assemblies.

In both modes the piping arrangement connecting the supply tank and the receiver tank remain at the operating temperature of the transfer system in the transfer mode or at least close to the operating temperature. As a result, the transfer system can advantageously change between the idle mode and the transfer mode without requiring purging and cooling down or warming up the piping arrangement to the operating temperature. In this way energy and time can be saved.

In a useful embodiment the first pipe assembly conducts a liquid phase of the fluid, and the second pipe assembly conducts a gaseous phase of the fluid.

In a preferred embodiment the first and the second pipe assemblies form at least one other closed loop that is separate from the closed loop of the transfer lines.

Each individual pipe assembly can be arranged to form a closed loop enabling circulation of fluid to keep all parts of the pipe assemblies at operating temperature.

Advantageously, a connection pipe connects to pipe assemblies. The connection pipe forms a closed loop encompassing two different pipe assemblies to permit circulation of fluid through the connected pipe assemblies.

It has been found useful when a shut-off valve is arranged in the connection pipe that can selectively assume an open and closed state. The open state of the shut-off valve is associated with the idle mode of the transfer system in which the connection pipe is part of a closed loop. The closed state of the shut-off valve is associated with the transfer mode of the transfer system to prevent fluid from flowing through the connection pipe.

In a useful embodiment of the transfer system the first and the second transfer lines are divided into two sections, wherein each section is connected with the receiver and the supply tank, respectively, and wherein the sections of the first and second transfer lines are coupled with releasable couplings to each other. The releasable couplings allow for creating closed loops that enable the cooling of the piping arrangement in the transfer and the idle mode.

It is particularly advantageous when the sections of the first and second transfer line for in the idle mode of the transfer system for closed loops, each of which includes one pipe assembly.

Further advantages will become apparent when reading the following detailed description in connection with the attached drawing.

### BRIEF DESCRIPTION OF THE DRAWINGS

Exemplary embodiments of the present disclosure are illustrated in the drawings and are explained in more detail in the following description. In the figures, the same or similar elements are referenced with the same or similar reference signs. It shows:

FIGS. 1A, B a first embodiment of a transfer system according to the present disclosure in a transfer und idle mode, respectively,

FIGS. 2A, B a second embodiment of a transfer system according to the present disclosure in a transfer und idle mode, respectively,

FIGS. 3A, B a third embodiment of a transfer system according to the present disclosure in a transfer und idle mode, respectively, and

FIGS. 4A, B a fourth embodiment of a transfer system according to the present disclosure in a transfer und idle mode, respectively,

### DETAILED DESCRIPTION

The detailed description of embodiments makes reference to liquefied hydrogen as an example for temperature sensitive fluid. However, the invention is not limited to any specific temperature sensitive fluid. Liquefied hydrogen (LH2) is only chosen as an example of high importance for practical applications.

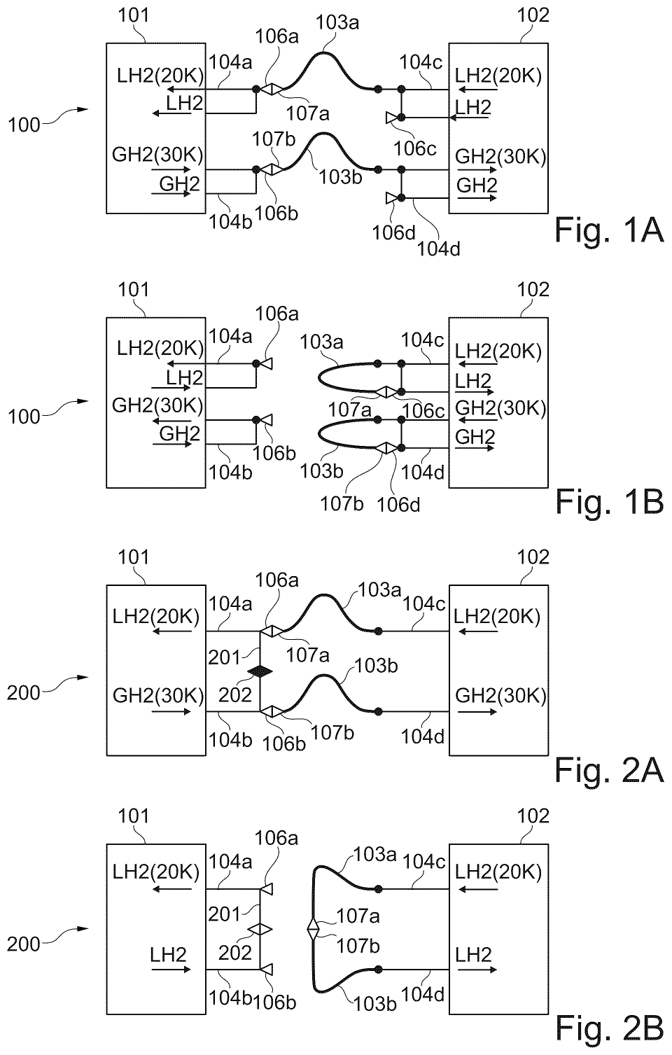

FIG. 1A shows a schematic illustration of a first embodiment of a transfer system 100 in a transfer operation mode. The transfer system 100 includes a receiver and a supply tank 101, 102 which are interconnected by a first and a second transfer line 103a, 103b. The receiver tank 101 is equipped with fixedly attached pipe assemblies 104a, 104b, each of which forms a closed loop that is provided with a detachable coupling 106a, 106b. The couplings are for instance self-closing dry QC/DC (quick connect/disconnect) couplings, which are known in the art. Likewise, the supply tank 102 is equipped with fixedly attached pipe assemblies 104c, 104d, which are provided with detachable couplings 106c, 106d, respectively. The pipe assemblies 104c, 104d also form closed loops similar to the pipe assemblies 104a, 104b. One end of the transfer line 103a is fixedly attached to the pipe assembly 104c. The other end of the first transfer line 103a is fitted with a coupling 107a, which is coupled with the coupling 106a of the pipe assembly 104a. One end of the second transfer line 103b is fixedly attached to the pipe assembly 104d of the supply tank 102. The other end of the second transfer line 103b is fitted with a coupling 107b, which is coupled with the coupling 106b of the pipe assembly 104b of the receiver tank 101. In the transfer mode shown in FIG. 1A liquefied fluid, for instance LH2 is transferred from the supply tank 102 to the receiver tank 101 through the first transfer line 103a. Gaseous fluid is flowing back through the second transfer line 103b from the receiver tank 101 to the supply tank 102 where it is reliquefied by a cooling system (not shown). In this way no gaseous fluid escapes into the environment. In the case of LH2 the temperature of the liquefied with his 20 K and the temperature of the gaseous fluid, namely gaseous hydrogen (GH2) is 30 K.

When the filling of the receiver tank 101 is completed, for instance when it is filled up to its maximum capacity, the coupling 107a is separated from coupling 106a and connected with coupling 106c of the supply tank 102. Similarly, the coupling 107b is separated from coupling 106b and connected with coupling 106d of the supply tank 102. This configuration of the transfer system 100 is shown in FIG. 1B and corresponds to an idle mode of the transfer system 100.

In the idle mode of the transfer system 100 shown in FIG. 1B liquefied fluid flows through transfer line 103a and cold gaseous fluid flows through the transfer line 103b. In this way, the first and second transfer lines 103a,b are kept at operating temperature. At the same time the pipe assemblies 104c and 104d are kept at operating temperature as well because liquefied fluid circulates through the pipe assembly 104a and gaseous fluid flows through the pipe assembly 104b coupled with the receiver tank 101. Due to the continuous flow of cold fluid through the pipe assemblies 104a,b also the couplings 106a,b are maintained at low temperatures. As a result, in the idle mode of the transfer system there are essentially no parts of the transfer system 100 that warm up and need to be cooled down and purged before the transfer system 100 returns to the transfer mode. In the application case of the transfer of LH2 the temperature of liquefied fluid is 20 K and the temperature of gaseous fluid is 30 K.

The transfer lines 103a,b and the pipe assemblies 104a-d as a whole are referred to as piping arrangement.

In FIGS. 2A and 2B another embodiment of a transfer system 200 according to the present disclosure is shown. The main difference between the transfer system 200 and the transfer system 100 is that the pipe assemblies 104a-d in the transfer system 200 are simplified to straight pipes without forming individual loops. In spite of this simplification, the term “pipe assembly” will be used also in connection with the transfer system 200. One end of the first transfer line 103a is fixedly connected with the pipe assembly 104c and the other end of the first transfer line 103a is provided with a coupling 107a that is coupled with the coupling 106a arranged at the pipe assembly 104a connected with the receiver tank 101. One end of the second transfer line 103b is fixedly connected with the pipe assembly 104d and the other end of the second transfer line 103b is provided with a coupling 107b that is coupled with the coupling 106b arranged at the pipe assembly 104b connected with the receiver tank 101. A connection pipe 201 connects the pipe assemblies 104a and 104b. A shut-off valve 202 allows for selectively activating or deactivating the connection pipe 201, i.e. selectively allowing or blocking the flow of fluid between the pipe assemblies 104a and 104b when the shut-off valve 202 is in its open or closed state, respectively.

FIG. 2A shows the transfer system 200 in the transfer mode, i.e. when liquefied fluid (e.g. LH2) is transferred through the transfer line 103a from the supply tank 102 two the receiver tank 101. In the transfer mode the shut-off valve 202 is closed and prevents flow of fluid between the pipe assemblies 104a and 104b. Gaseous fluid passes from the receiving tank 101 through the transfer line 103b back to the supply tank 102 where it is reliquefied. It is noted that the pipe sections of connection pipe 201 between the pipe assemblies 104a and 104b remain at low temperatures due to turbulent flow of fluid from the transfer lines 103a and 103b.

FIG. 2B shows the transfer system 200 in the idle mode, i.e. when no liquefied fluid is transferred from the supply tank 102 two the receiver tank 101. In the idle mode coupling 107a of the first transfer line 103a is coupled to coupling 107b of the second transfer line 103b. Liquefied fluid flows through the first and the second transfer line 103a, 103b and keeps them at low temperatures. On the side of the receiver tank 101 the shut-off valve 202 is open and liquefied fluid is pumped through the pipe assemblies 104a and 104b, which are connected by the connection pipe 201. In this way also the pipe assemblies 104a, 104b and the couplings 106a, 106b are kept at low temperatures.

Alternatively, cold gaseous fluid can be used to keep the piping arrangement at or at least near the operating temperature of the transfer system in its transfer mode.

In order to return to the transfer mode of the transfer system 200 it is sufficient to close the shut-off valve 202, to decouple the coupling 107a from 107b and couple the coupling 107a and 107b with the coupling 106a and 106b, respectively. Cooling down and/or purging of the transfer lines 103a, 103b and the pipe assemblies 104a-d is not necessary.

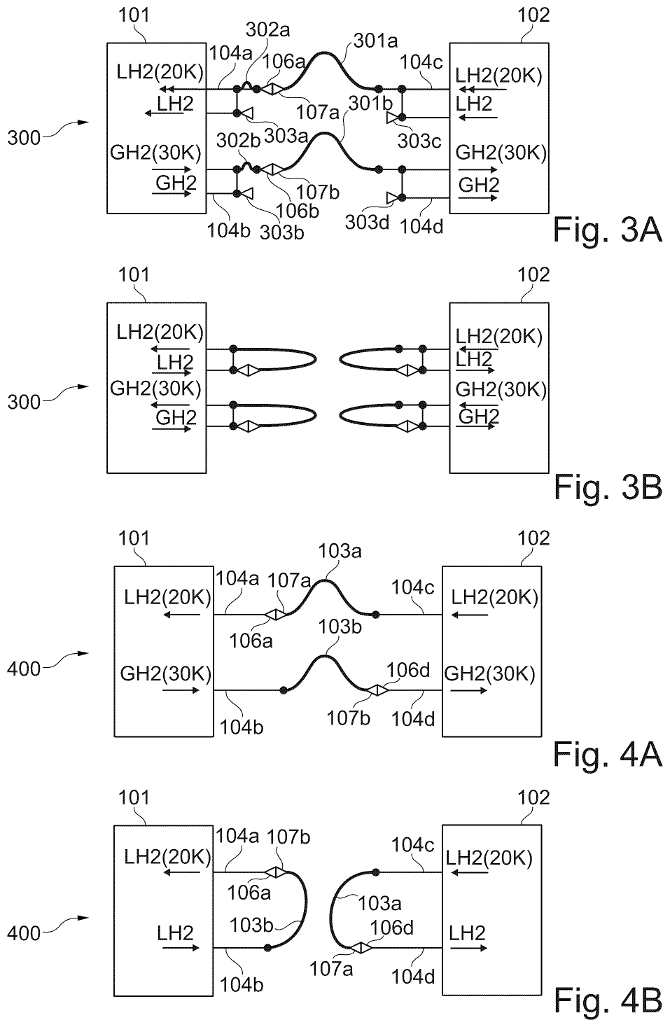

FIGS. 3A and 3B illustrates another embodiment of a transfer system 300 according to the present disclosure. The transfer system 300 is very similar to the transfer system 100 and one difference is that the first transfer line 103a is replaced by two flexible transfer lines 301a and 302a. One end of transfer line 301a is fixedly connected with pipe assembly 104c and the other end of transfer line 301a is provided with the coupling 107a. One end of transfer line 302a is fixedly connected with pipe assembly 104a and the other end of transfer line 302a is provided with the coupling 106a. Likewise, one end of transfer line 301b is fixedly connected with pipe assembly 104d and the other end of transfer line 301b is provided with the coupling 107b. One end of transfer line 302b is fixedly connected with pipe assembly 104b and the other end of transfer line 302b is provided with the coupling 106b. In addition to that, every pipe assembly 104a-d is provided with a coupling 303a-d.

In the transfer mode shown in FIG. 3A the couplings 107a and 106a of transfer lines 301a and 302a are coupled. Similarly, the couplings 107b and 106b of transfer lines 301b and 302b are coupled. In the transfer mode liquefied fluid flows from the supply tank 102 through the pipe assembly 104c and through the transfer lines 301a and 302a to the pipe assembly 104a to the receiver tank 101. Gaseous fluid flows in the opposite direction through pipe assembly 104b through the transfer lines 302b and 302a to the pipe assembly 104 into the supply tank 102.

FIG. 3B shows the idle mode of the transfer system 300. To transition the transfer system from the transfer mode shown in FIG. 3A to the idle mode, the couplings 106a, 107a and 106b, 107b are decoupled from one another and coupled to the couplings 303a-d such that close to loops are formed by the transfer lines 301a,b 302a,b including the pipe assemblies 104a-d. As a result, liquefied fluid flows through the transfer lines 301a and 302a and the pipe assemblies 104a and 104c. Similarly, gaseous fluid flows through the transfer lines 301b and 302b and the pipe assemblies 104b and 104d. In this way, all transfer lines and pipe assemblies are kept at low temperatures enabling transitioning from the idle mode into the transfer mode without requiring cooling down or purging of the transfer lines and pipe assemblies.

FIGS. 4A and 4B show yet another transfer system 400 according to the present disclosure. The transfer system 400 is very similar to the transfer system 200. The pipe assemblies 104a-d are simplified again to straight pipes.

In the transfer mode shown in FIG. 4A, one end of the first transfer line 103a is fixedly connected with the pipe assembly 104c. the other end of the first transfer line 103a is equipped with a first coupling 107a connected with a coupling 106a arranged at the pipe assembly 104a. One end of the second transfer line 103b is fixedly connected with the pipe assembly 104b. The other end of the transfer line 103b is equipped with a coupling 107b is coupled to a coupling 106d arranged at the pipe assembly 104d. In this transfer mode liquefied fluid flows from the supply tank 102 through the pipe assembly 104c, the first transfer line 103a, the pipe assembly 104a to the receiver tank 101. Gaseous fluid returns through the pipe assembly 104b, the second transfer line 103b and the pipe assembly 104d into the supply tank.

In the idle mode when no fluid is transferred from the supply tank 102 to the receiver tank 101, the coupling 107a of the first transfer line 103a is coupled with the coupling 106d of the pipe assembly 104d. Likewise the second transfer line 103b is coupled with a coupling 107b to the coupling 106a of the pipe assembly 104a. In the idle mode liquefied fluid flows through the first and the second transfer line 103a,b and keeps them at low temperatures. Alternatively, cold gaseous fluid keeps the piping arrangement at or at least near the operating temperature of the transfer system in the transfer mode.

In order to return from the idle mode into the transfer mode only the couplings 107a and 107b of the first and second transfer lines 103a,b need to be decoupled and re-coupled as shown in FIG. 4A. The transition from the idle mode to the transfer mode is possible without requiring cooling down or purging of the transfer lines.

The embodiment of the transfer system according to the present disclosure has been described with liquefied hydrogen (LH2) as an example for a temperature sensitive fluid, the present disclosure is not limited to a specific temperature sensitive fluid.

In the claims, the word “comprising” does not exclude other elements or steps, and the indefinite article “a” does not exclude a plurality.

A single unit or device may perform the functions of multiple elements recited in the claims. The fact that individual functions and elements are recited in different dependent claims does not mean that a combination of those functions and elements could not advantageously be used.

### LIST OF REFERENCE SIGNS

100 Transfer system
10 Receiver tank
102 Supply tank
103a,b Transfer line
104a-d Pipe assembly
106a-d Coupling
107a,b Coupling
20 Connection pipe
202 Shut-off valve
301a,b Transfer line
302a,b Transfer line
303a-d Coupling

1. A transfer system for transferring temperature sensitive fluids from a supply tank to a receiver tank, wherein the supply tank and the receiver tank are fluidly connected by a piping arrangement, said piping arrangement comprising:
at least two thermally insulated transfer lines; and
first and second piping assemblies associated with the receiver and the supply tank, respectively, wherein one end of each transfer line is connected with one of the supply and receiver tank and the other end of each transfer line is provided with a coupling for coupling the other end with the other one of the supply and receiver tank,
wherein the transfer system is selectively operable in a transfer mode and an idle mode by appropriately coupling and decoupling the first and second transfer lines,
wherein, in the transfer mode, the first and the second transfer lines fluidly connect the supply tank with the receiver tank, such that fluid flows through the first and second transfer lines and the first and second pipe assemblies, and in that, in the idle mode, the first and second transfer lines form a closed loop enabling a continuous flow of fluid through the first and second transfer lines, and in that the first and the second pipe assemblies are part of the closed loop enabling a continuous flow of fluid through the first and the second pipe assemblies.

2. The transfer system according to claim 1, wherein the first pipe assembly conducts a liquid phase of the fluid, and the second pipe assembly conducts a gaseous phase of the fluid.

3. The transfer system according to claim 1, wherein the first and the second pipe assemblies form at least one other closed loop that is separate from the closed loop of the transfer lines.

4. The transfer system according to claim 1, wherein a connection pipe connects two pipe assemblies.

5. The transfer system according to claim 4, wherein a shut-off valve is arranged in the connection pipe that can selectively assume an open and a closed state.

6. The transfer system according to claim 1, wherein the first and the second transfer lines are divided into two sections, wherein each section is connected with the receiver and the supply tank, respectively, and wherein the sections of the first and second transfer lines are coupled with releasable couplings to each other.

7. The transfer system according to claim 6, wherein the sections of the first and second transfer line form closed loops in the idle mode of the transfer system, wherein each of the closed loops includes one pipe assembly.
